(19) United States
(12) Patent Application Publication
(10) Pub. No.: US 2011/0146271 A1
(43) Pub. Date: Jun. 23, 2011

(54) GAS EXPANDER SYSTEM

(76) Inventors: Jeffrey Carter, Mirfield (GB); Stephen Edward Garrett, Huddersfield (GB); Michael Cummings, Holmfirth (GB)

(21) Appl. No.: 12/719,590

(22) Filed: Mar. 8, 2010

(30) Foreign Application Priority Data
Mar. 6, 2009 (GB) 0903830.8

(51) Int. Cl. F02C 6/12; F01D 15/12

(52) U.S. Cl. 60/605.1; 415/122.1

(57) ABSTRACT

According to an aspect of the present invention, there is provided a gas expander system suitable for use in a turbomachine, the gas expander system comprising: a gas expander provided with a moveable part; a magnetic gear arrangement; and a shaft; the moveable part of the gas expander being connectable to a load via the magnetic gear arrangement and the shaft, and movement of the moveable part of the gas expander being arranged to cause movement of the shaft.

The present invention relates to a gas expander system, and in particular to a gas expander system suitable for use in a turbomachine (e.g. a machine comprising a turbocharger, such as a motor vehicle).

Turbochargers are well known devices for supplying air to the intake of an internal combustion engine at pressures above atmospheric pressure (boost pressures). A conventional turbocharger essentially comprises an exhaust gas driven turbine wheel mounted on a rotatable shaft within a turbine housing connected downstream of an engine outlet manifold. Rotation of the turbine wheel rotates a compressor wheel mounted on the other end of the shaft within a compressor housing. The compressor wheel delivers compressed air to an engine intake manifold. The turbocharger shaft is conventionally supported by journal and thrust bearings, including appropriate lubricating systems, located within a central bearing housing connected between the turbine and compressor wheel housings.

In known turbochargers, the turbine stage comprises a turbine chamber within which the turbine wheel is mounted; an annular inlet passageway defined between facing radial walls arranged around the turbine chamber; an inlet volute arranged around the inlet passageway; and an outlet passageway extending from the turbine chamber. The passageways and chambers communicate such that pressurised exhaust gas admitted to the inlet chamber flows through the inlet passageway to the outlet passageway via the turbine and rotates the turbine wheel. It is also known to improve turbine performance by providing vanes, referred to as nozzle vanes, in the inlet passageway so as to deflect gas flowing through the inlet passageway towards the direction of rotation of the turbine wheel.

Turbines may be of a fixed or variable geometry type. Variable geometry turbines differ from fixed geometry turbines in that the size of the inlet passageway can be varied to optimise gas flow velocities over a range of mass flow rates so that the power output of the turbine can be varied to suit varying engine demands. For instance, when the volume of exhaust gas being delivered to the turbine is relatively low, the velocity of the gas reaching the turbine wheel is maintained at a level which ensures efficient turbine operation by reducing the size of the annular inlet passageway. Turbochargers provided with a variable geometry turbine are referred to as variable geometry turbochargers.

Some turbomachines are provided with a power turbine. A power turbine may be used, for example, to transmit power to an engine crankshaft. The power turbine may be powered by exhaust gases leaving a turbine housing of a turbocharger. Since exhaust gases are used to provide power to the engine crankshaft, the overall efficiency of the turbomachine may be improved by the incorporation of the power turbine.

Whereas the turbine of a turbocharger drives a compressor, in a power turbine the end of the turbine shaft remote from the turbine wheel transmits power via a mechanical coupling. In a turbocompound engine comprising a power turbine connected in series with the turbine of a turbocharger, a gear wheel may be fixed to the end of the power turbine shaft to transmit power to the crankshaft of the engine via an appropriate coupling (for example, a mechanical gear). As with a turbocharger, the shaft of a power turbine is supported on bearing assemblies, including appropriate lubricating systems, located within a bearing housing connected to the turbine housing. The bearing arrangement at the turbine end of the shaft may be substantially the same as that found in a turbocharger, although the bearing arrangement at the drive end of the shaft May be a ball bearing assembly.

A power turbine may alternatively or additionally be provided in machines that do not have a turbocharger. Furthermore, a power turbine may be used to transmit power to something other than an engine crankshaft. For instance, a power turbine may be used to transmit power to, or generate power in, any suitable load, such as an electrical, hydraulic or mechanical arrangement. Although the power turbine has been described as comprising a turbine wheel, other gas expanders may be used instead of a turbine wheel (a gas expander being a device in which expansion of a gas may be used to derive mechanical work). For instance, the gas expander could be of a piston-type, a swash-plate type, or a screw-type expander. Generically speaking, then, a gas expander may be connected to a load. In known arrangements, the gas expander may be connected to the load via a moveable (for example, rotatable) shaft and a mechanical coupling such as a mechanical gear.

Gas expanders that are connected to, or are connectable to a load via a moveable shaft and a mechanical coupling (such as a mechanical gear) are well known, and have been in use for many decades. A gas expander, one or more moveable shafts and a coupling (e.g. a mechanical gear) may together be referred to as a gas expander system. Despite the existence of such gas expander systems over long period of time and in a wide variety of applications, there are problems associated with the use of such gas expander systems. The problems lie in the use of a mechanical gear in the gas expander system. The use of a mechanical gear requires continued maintenance, for example by way of the provision of a lubricant or the like. The efficiency of the mechanical gear could also be improved. A mechanical gear may also become damaged if excessive force is applied to the gear, for example via a torque in an input or output shaft to which the gear is connected. Another problem is the need to ensure consistently accurate alignment between members of a mechanical gear (e.g. cogs, or the like) over the lifetime of the mechanical gear. A further problem is the inherent high level of acoustic noise and vibration that is associated with the use of mechanical gears

It is an object of the present invention to provide a gas expander system that obviates or mitigates at least one problem of the prior art, whether identified herein or elsewhere.

According to an first aspect of the present invention, there is provided a gas expander system suitable for use in a turbomachine, the gas expander system comprising: a gas expander provided with a moveable part; a magnetic gear arrangement; and a shaft; the moveable part of the gas expander being connectable to a load via the magnetic gear arrangement and the shaft, and movement of the moveable part of the gas expander being arranged to cause movement of the shaft.

By connecting the moveable part of the gas expander to a load via the magnetic gear arrangement and the shaft, one or more problems associated with the use of mechanical gears as used in existing gas expander systems can be obviated or mitigated in comparison with mechanical gears, magnetic gears require reduced maintenance and offer improved reliability. Magnetic gears are lubrication free in some embodiments, and other embodiments require less lubrication than mechanical gears. Magnetic gears are more efficient than conventional mechanical gears. Magnetic gears offer precise peak torque transmission and inherent overload protection (e.g. the magnetic gears are not damaged when an excessive force is applied to the magnetic gear which would, in mechanical gears, cause damage to teeth of the gears).

The use of the magnetic gear may allow the physical isolation between an input and an output shaft and this can be taken advantage of as described in more detail below. Magnetic gears offer inherent anti-jamming transmission and significantly reduce potentially harmful drive-train pulsations. Furthermore, magnetic gears allow for misalignment of for example, input and output shafts of the gas expander system. Finally, when operating, magnetic gears have very low inherent acoustic noise and vibration in comparison with mechanical gears.

According to a second aspect of the present invention, there is provided a turbocharger system comprising: a turbocharger, comprising a turbine and a compressor; the gas expander system according to the first aspect of the invention.

The system (i.e. the gas expander system, and/or the turbocharger system) may be arranged such that a gas flowing into or out of the turbocharger or the gas expander is arranged to cause movement of the moveable part of the gas expander.

The system may comprise, in use, a source of heat. The source of heat may be provided by, in use, a part of the turbocharger system, an engine to which the turbocharger is connected, or a fluid flowing into or out of the turbocharger or the engine. The source of heat may be arranged to heat a working fluid provided in a closed-loop system and cause expansion of that working fluid.

Expansion of the working fluid in a gaseous form in the closed loop system may be arranged to move the moveable part of the gas expander. The moveable part of the gas expander may be located within the closed loop system. The magnetic gear may comprise a first rotor and a second rotor, the first rotor and second rotor being separated from one another by at least a part of a wall forming part of the closed loop system. The at least a part of a wall forming part of the closed loop system that separates the first rotor from the second rotor may comprises (e.g. may be attached to or form part of) a stator of the magnetic gear.

The system may further comprise an impeller arranged to induce a fluid flow through the magnetic gear arrangement. The impeller may be attached to or form part of a rotor of the magnetic gear arrangement. One or more members of the magnetic gear arrangement may be provided with surface profiling or apertures configured to induce a fluid flow through the magnetic gear arrangement. The surface profile may comprise rifling. The fluid flow through the magnetic gear arrangement may, in general, be arranged to be directed radially away from an axis about which one or more members of the magnetic gear arrangement is configured to rotate. The fluid flow through the magnetic gear arrangement may be configured to have a serpentine like path through the magnetic gear arrangement, such that the fluid passes along one or more surfaces of two or three members of the magnetic gear arrangement (e.g. to improve cooling of those surfaces). A housing or casing of one or more members of the magnetic gear arrangement is configured (e.g. shaped) to direct, or assist in the direction of, the flow of air in the serpentine like path.

The magnetic gear arrangement may comprise a first rotor, a second rotor, and a magnetic gear member, and wherein the magnetic gear member is rotatable. The magnetic gear member may be located in-between the first rotor and the second rotor. The magnetic gear member may be selectively allowed to freewheel. The system further comprises an electricity generation arrangement for generating electricity from rotation of the magnetic gear member.

The system may further comprise a driving arrangement configured to drive rotation of the magnetic gear member. The magnetic gear arrangement may be configured such that, when the magnetic gear member is not rotated by the driving arrangement, the magnetic gear arrangement has a first, inherent, gear ratio. The magnetic gear arrangement may be configured such that, when the magnetic gear member is arranged to be rotated by the driving arrangement, the magnetic gear arrangement has a second gear ratio that is related to the first, inherent, gear ratio as defined by:

(Sₘₘ−S_{fr})/R=Sₛᵣ

where Sₘₘ the speed of the magnetic gear member, S_{fr} is the speed of the first rotor, Sₛᵣ is the speed of the second rotor and R is the first, inherent, gear ratio. The driving arrangement may comprise a motor having a motor shaft. The driving arrangement may further comprise an abutment member (e.g. a cog or gear or disc like member) attached to or forming a part of the motor shaft and which abuts against the magnetic gear member. Rotation of the shaft may thus cause rotation of the abutment member, which in turn causes rotation of the magnetic gear member.

The magnetic gear arrangement may comprise a first rotor, a second rotor, and a magnetic gear member located, in use, in-between the first rotor and the second rotor, and wherein the magnetic gear member is moveable into and out of a position substantially in-between the first rotor and the second rotor. The magnetic gear member may be moveable in a radial direction (e.g. if the first rotor, second rotor, and magnetic gear member are disc-like in shape) or in an axial direction (e.g. if the first rotor, second rotor, and magnetic gear member are cylinder-like in shape). The magnetic gear member may be moveable in any suitable way, for example in a circumferential direction (e.g. in a direction parallel, perpendicular or tangential to a circumference of the magnetic gear member).

The magnetic gear arrangement may comprise a first rotor, a second rotor, and a magnetic gear member located in-between the first rotor and the second rotor, and wherein the magnetic gear member comprises a first part of the magnetic gear member and a second part of the magnetic gear member, relative movement being possible between the first part of the magnetic gear member and the second part of the magnetic gear member. One or both of the first part of the magnetic gear member and second part of the magnetic gear member are moveable from a first position to a second position, the first position being such that magnetic flux is prevented from passing from the first rotor to the second rotor, or from the second rotor to the first rotor, and the second position being such that magnetic flux is allowed to pass from the first rotor to the second rotor, or from the second rotor to the first rotor. The first configuration may be when pole-pieces of the first and second parts of the magnetic gear member are not aligned with one another, and the second configuration may be when pole-pieces of the first and second parts of the magnetic gear member are in alignment with one another

The magnetic gear arrangement may comprise a first rotor, a second rotor and a magnetic gear member located in-between the first rotor and the second rotor, and wherein the first rotor, second rotor and magnetic gear member each have a substantially cylindrical shape. Alternatively, the magnetic gear arrangement may comprise a first rotor, a second rotor and a magnetic gear member located in-between the first rotor and the second rotor, and wherein the first rotor, second rotor and magnetic gear member each have a substantially disc-like shape. The magnetic gear member may be a stator of the magnetic gear arrangement. The first rotor and second rotor may each comprises a plurality of permanent magnets. The magnetic gear member (e.g. the stator) may comprise a plurality of pole pieces.

The moveable part of the gas expander system may be rotatable. The shaft of the gas expander system may be rotatable.

The gas expander may be one of a group comprising: a turbine, a piston-type expander, a swash-plate type expander, or a screw-type expander. The moveable part may be a turbine wheel, a piston, a swath-plate or a screw-type arrangement (e.g. having a screw-like thread).

The moveable part of the gas expander may be connected to a first rotor of the magnetic gear by a first shaft, and a second rotor of the magnetic gear is connectable to the load via a second shaft.

The load may comprise one of a group comprising: an electricity generator (e.g. an alternator or a dynamo); a hydraulic system; a mechanical transmission; a mechanical gear; an engine crankshaft.

The gas expander may be a turbine, the moveable part of the gas expander being a turbine wheel, the gas expander forming part of a turbocharger, and wherein the system may further comprise a the load, the load being a compressor wheel of the turbocharger.

A turbocharger may be provided that incorporates the gas expander system as described herein.

Embodiments of the present invention will now be described, by way of example only, with reference to the accompanying Figures, in which:

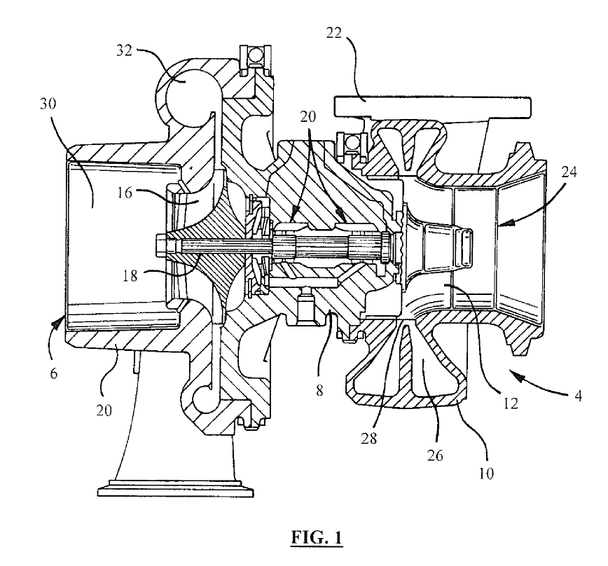

FIG. 1 is a section-view schematically depicting an embodiment of a turbocharger;

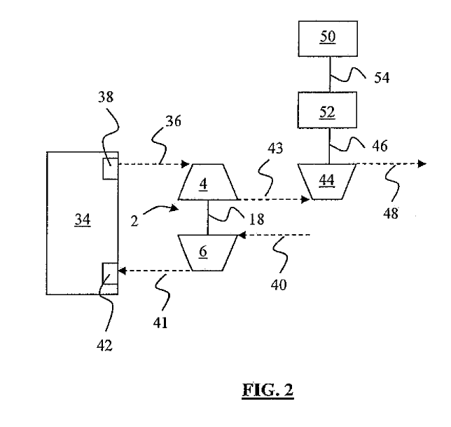

FIG. 2 schematically depicts an existing turbocompound engine system;

FIG. 3 schematically depicts in perspective view a part of an existing turbocompound engine system;

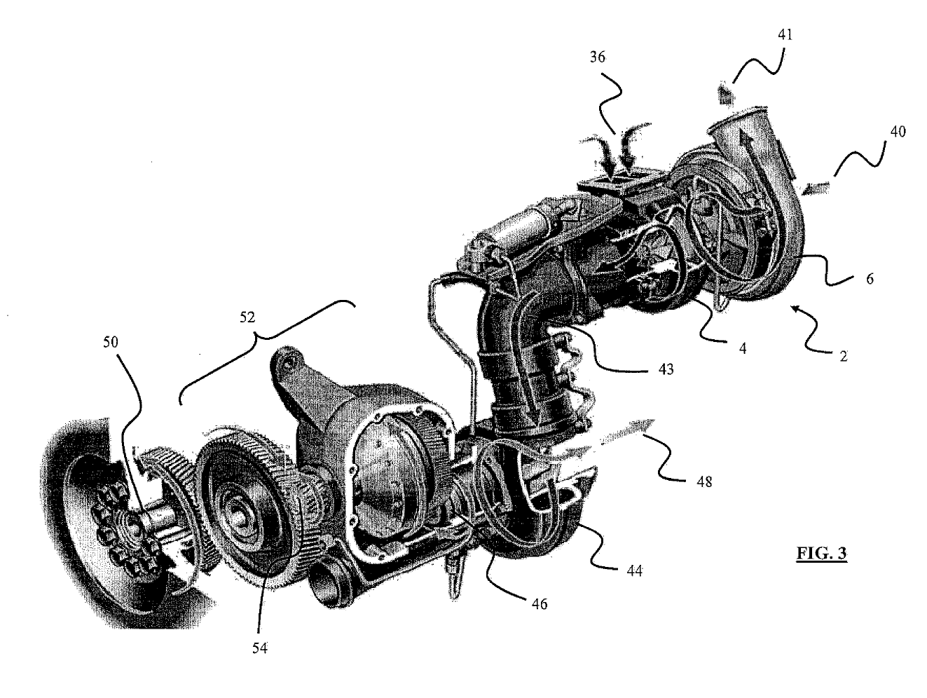

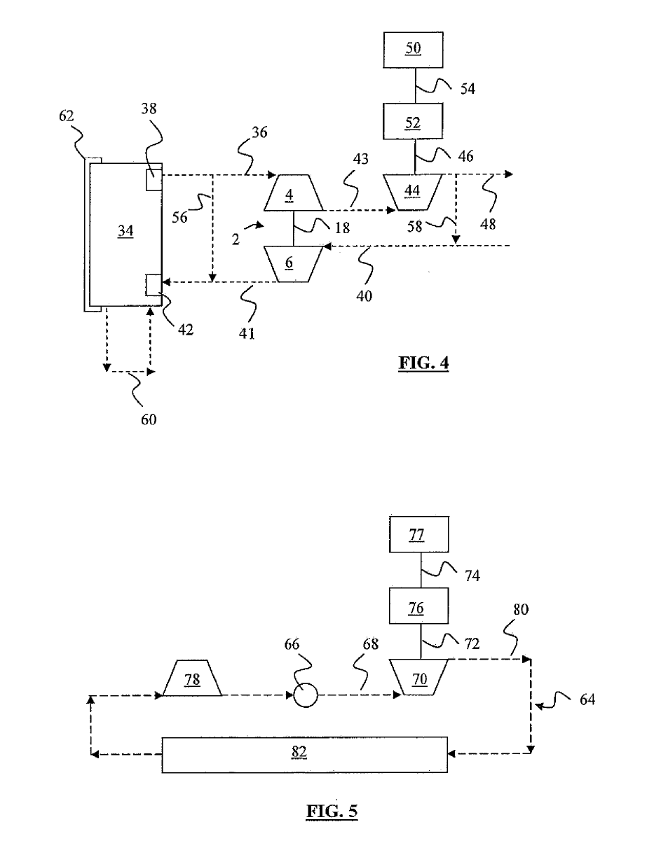

FIG. 4 schematically depicts another turbocompound engine system, together with potential sources of heat in that system;

FIG. 5 schematically depicts an embodiment of a waste heat recovery system that may be used in conjunction with the turbocompound engine system shown in and described with reference to FIG. 4;

FIG. 6 schematically depicts an end-on-view of a magnetic gear that may be used in a gas expander of the turbocompound engine systems shown in and described with reference to FIGS. 2 to 5;

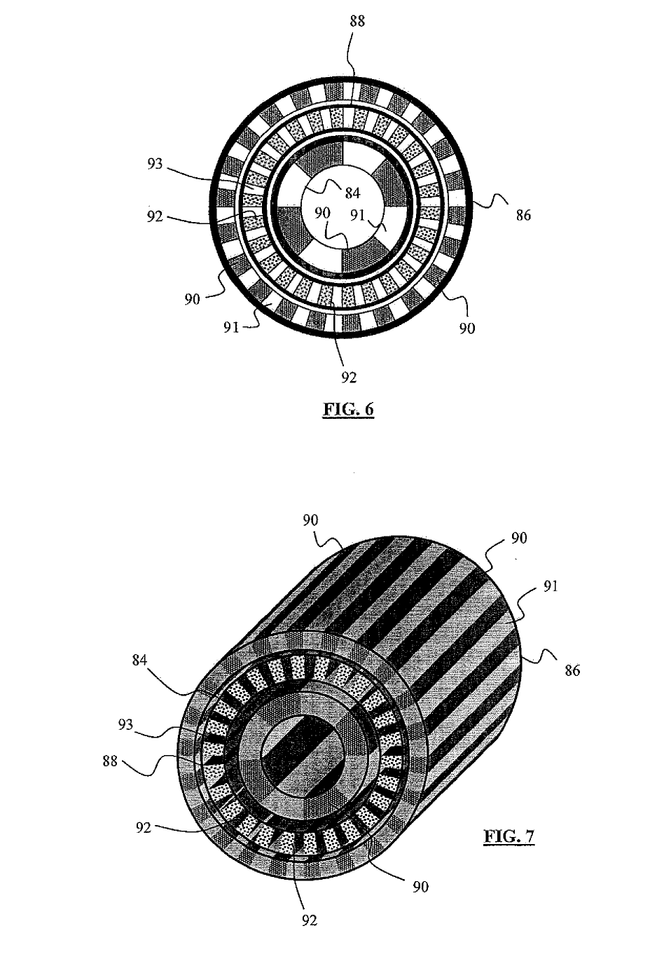

FIG. 7 schematically depicts in perspective-view the magnetic gear shown in and described with reference to FIG. 6;

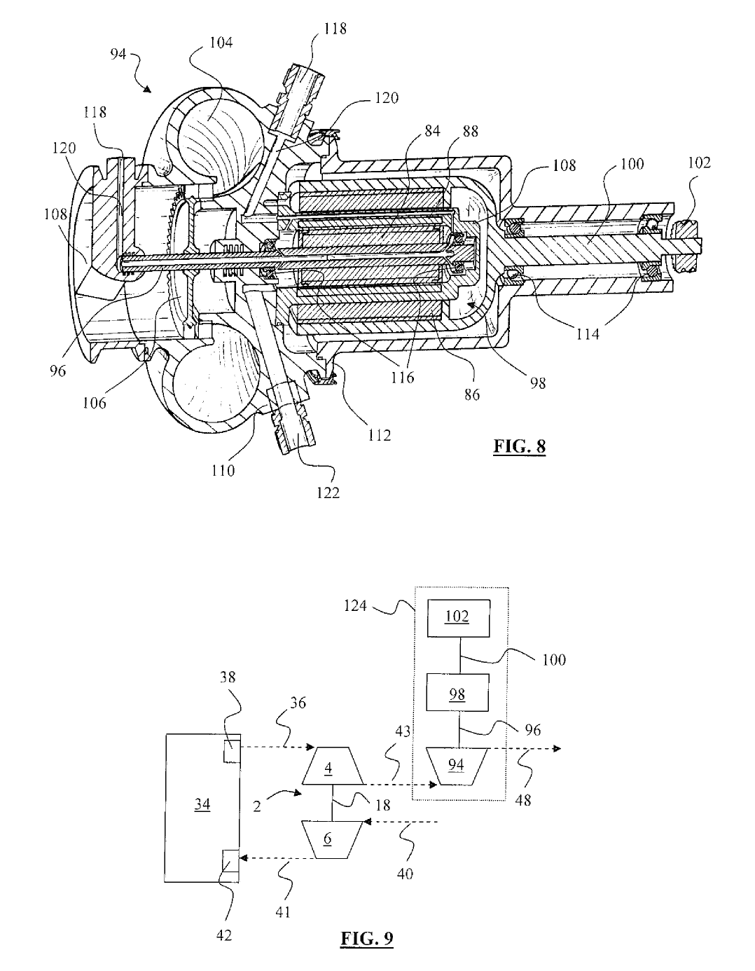

FIG. 8 schematically depicts a section-view of a gas expander system in accordance with an embodiment of the present invention;

FIG. 9 schematically depicts a turbocompound engine system incorporating the gas expander shown in and described with reference to FIG. 8;

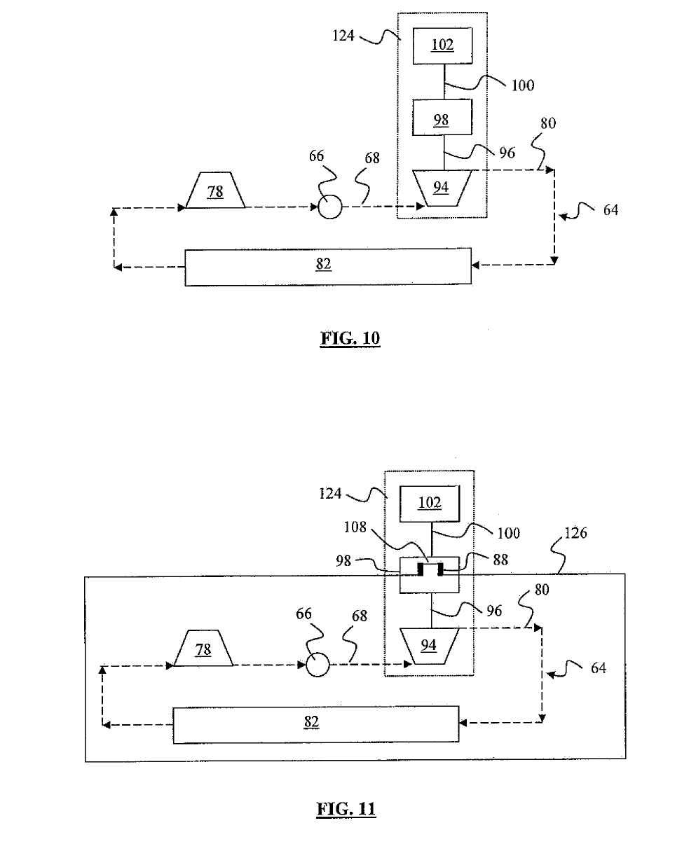

FIG. 10 schematically depicts a waste heat recovery system for use in a turobcompound engine system, incorporating the gas expander shown in and described with reference to FIG. 8;

FIG. 11 schematically depicts a modification to the waste heat recovery system of FIG. 10;

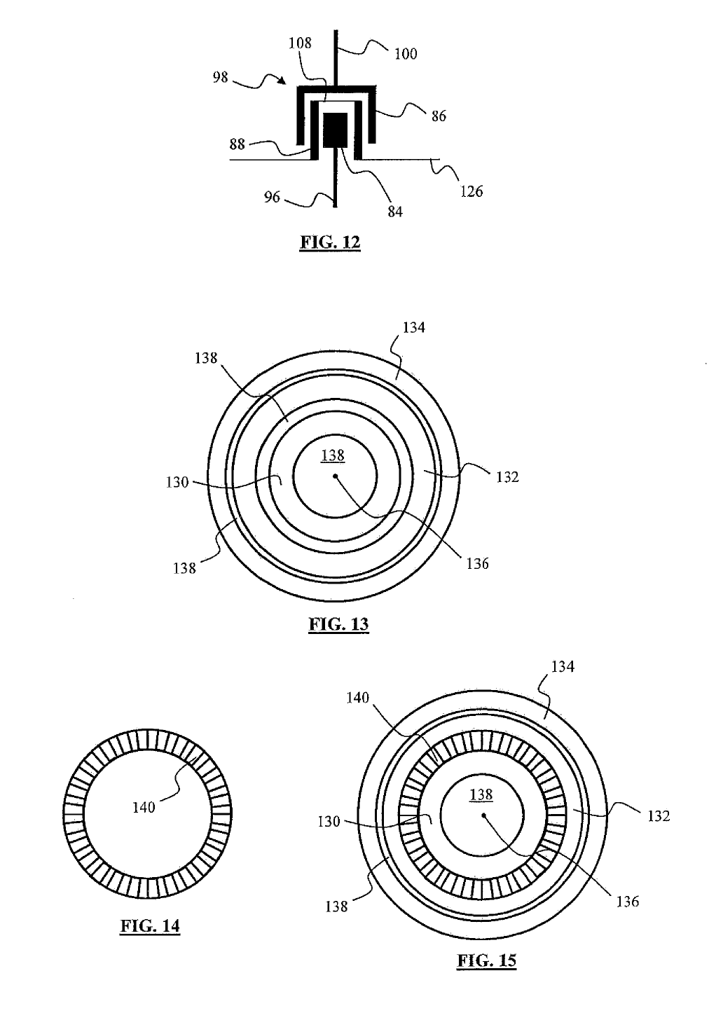

FIG. 12 schematically depicts an operating principle associated with the waste heat recovery system shown in and described with reference to FIG. 11;

FIG. 13 schematically depicts an end-on-view of a magnetic gear;

FIG. 14 schematically depicts an end-on-view of an impeller suitable for use in connection with the magnetic gear shown in and described with reference to FIG. 14;

FIG. 15 schematically depicts an end-on-view of the magnetic gear of FIG. 13 provided with the impeller of FIG. 14;

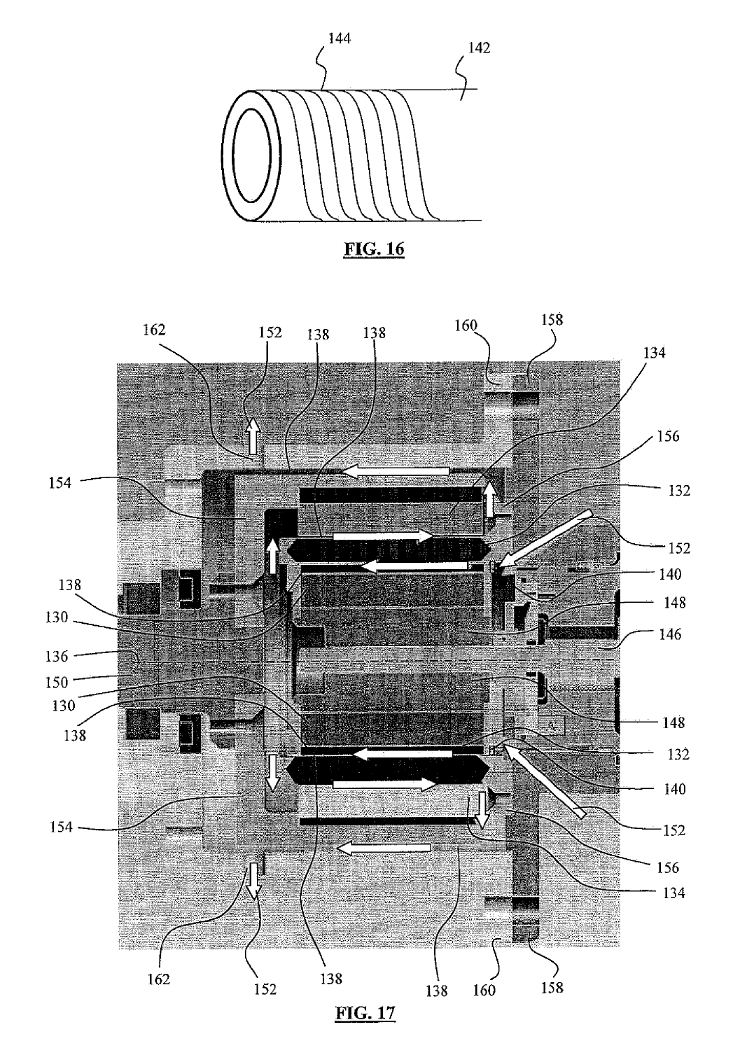

FIG. 16 schematically depicts a perspective-view of a member of the magnetic gear shown in and described with reference to FIG. 13, the member be provided with surface features in the form of rifling;

FIG. 17 schematically depicts a section-view of a magnetic gear, and the flow of air in an around that gear, in accordance with an embodiment of the present invention;

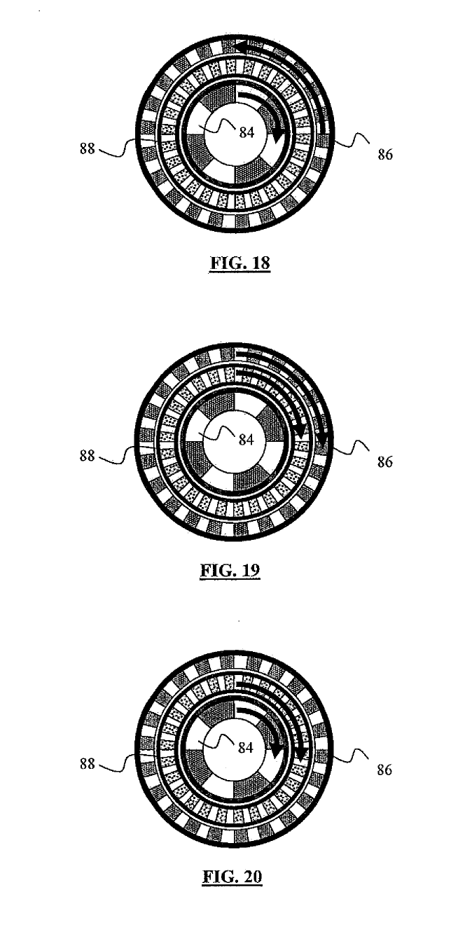

FIG. 18 schematically depicts an end-on-view of a magnetic gear together with relative movement of members of that magnetic gear;

FIG. 19 schematically depicts the effects on the relative movement of members of the magnetic gear when the stator of the magnetic gear is free to rotate, and an outer member of the magnetic gear is rotated;

FIG. 20 schematically depicts the effects on the relative movement of members of the magnetic gear when the stator of the magnetic gear is free to rotate, and an inner member of the magnetic gear is rotated;

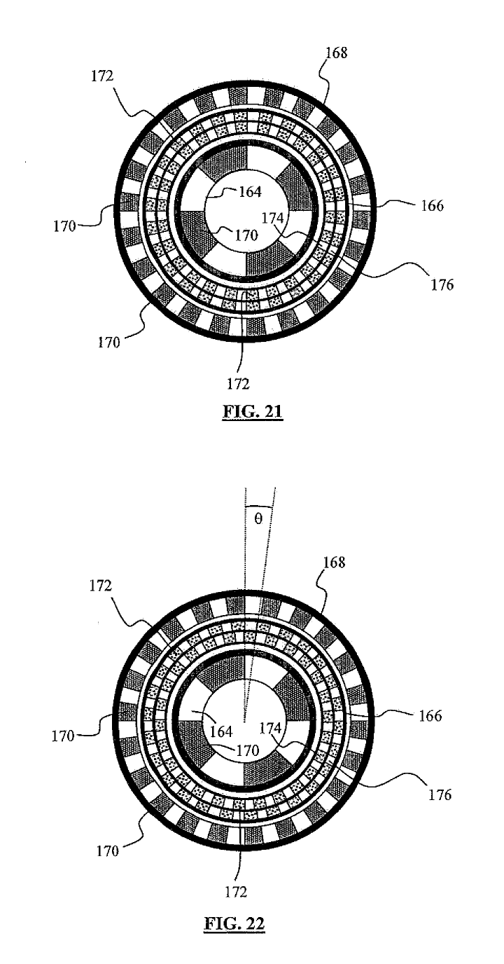

FIG. 21 schematically depicts an end-on-view of a magnetic gear in accordance with an embodiment of the present invention in which the stator of the magnetic gear comprises two concentric parts, one part being moveable relative to the other;

FIG. 22 schematically depicts relative movement between the first and second moveable parts of the stator of the magnetic gear shown in and described with reference to FIG. 21;

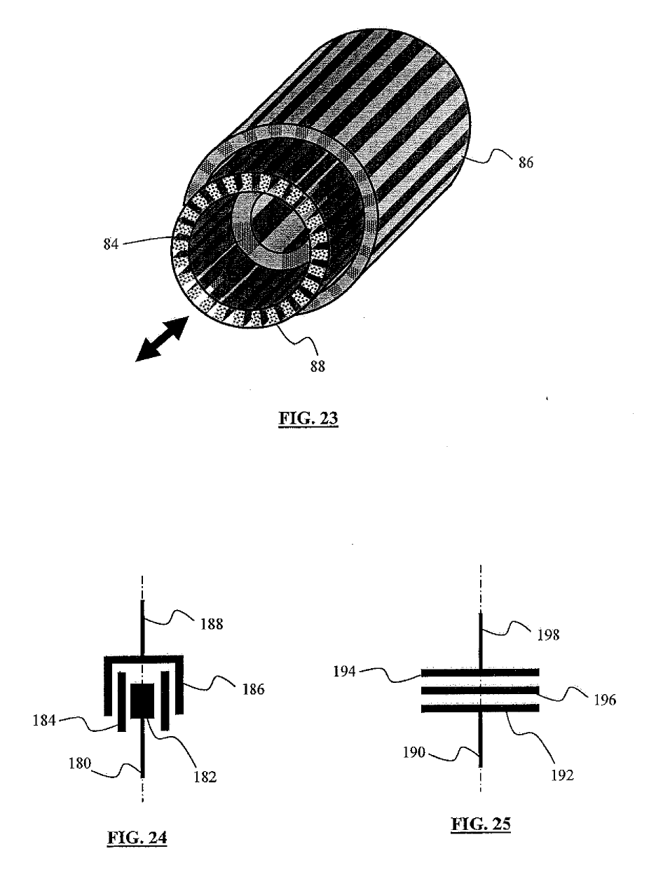

FIG. 23 schematically depicts a perspective-view of a magnetic gear in accordance with another embodiment of the present invention, in which a stator of the magnetic gear is axially moveable;

FIG. 24 schematically depicts a first magnetic gear arrangement;

FIG. 25 schematically depicts a second magnetic gear arrangement;

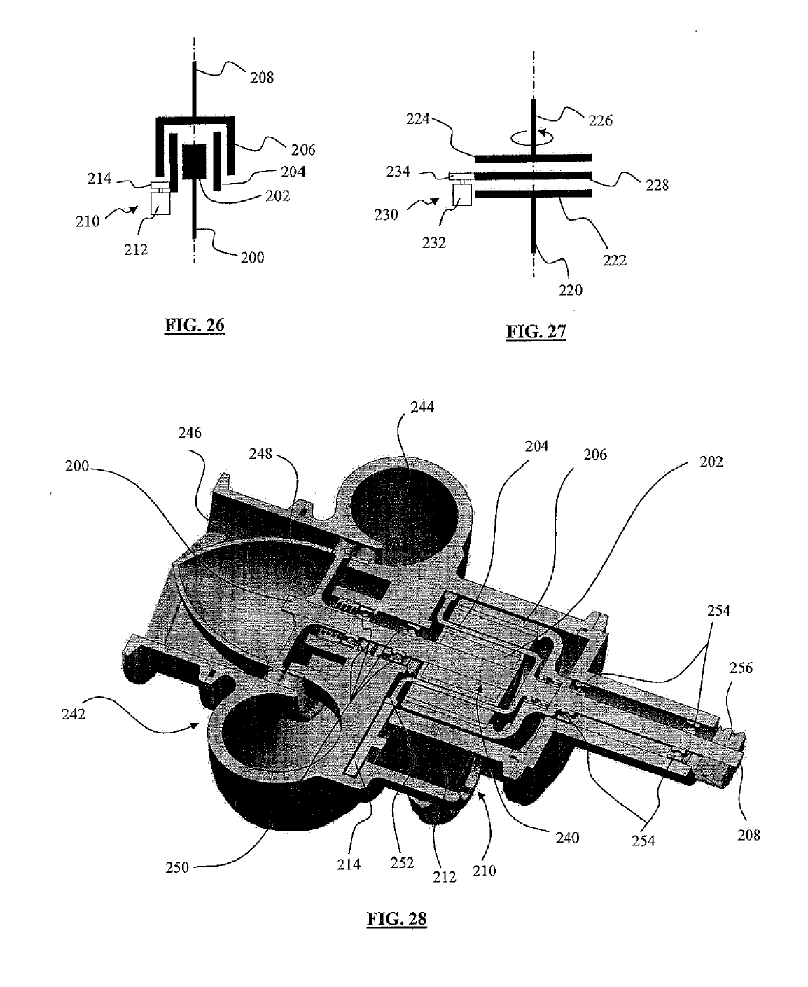

FIG. 26 schematically depicts a magnetic gear arrangement according to another embodiment of the present invention, in which a magnetic gear member may be rotated by a driving arrangement;

FIG. 27 schematically depicts a magnetic gear arrangement according to a further embodiment of the present invention, in which a magnetic gear member may be rotated by a driving arrangement;

FIG. 28 schematically depicts gas expander system provided with the magnetic gear arrangement of FIG. 26;

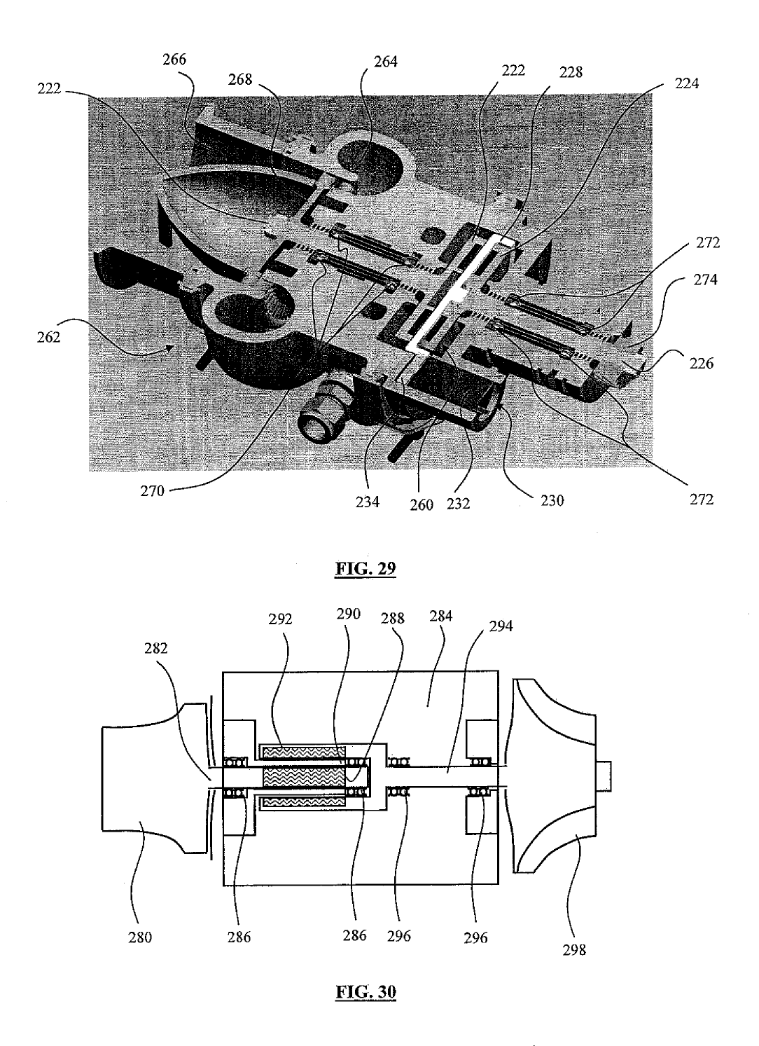

FIG. 29 schematically depicts gas expander system provided with the magnetic gear arrangement of FIG. 27; and

FIG. 30 schematically depicts a turbocharger provided with a gas expander system according to an embodiment of the present invention.

FIG. 1 is an axial cross-section through a typical turbocharger 2 with a fixed geometry turbine which illustrates the basic components of a turbocharger. The turbocharger 2 comprises a turbine 4 joined to a compressor 6 via a central bearing housing 8. The turbine 4 comprises a turbine housing 10 which houses a turbine wheel 12. Similarly, the compressor 6 comprises a compressor housing 14 which houses a compressor wheel 16 The turbine wheel 12 and compressor wheel 16 are mounted on opposite ends of a common turbo shaft 18 which is supported on bearing assemblies 20 within the bearing housing 8.

The turbine housing 10 is provided with an exhaust gas inlet 22 and an exhaust gas outlet 24. The inlet 22 directs incoming exhaust gas (e.g. from an engine outlet manifold) to an annular inlet chamber, i.e. a volute 26 surrounding the turbine wheel 12 and communicating therewith via a radially extending annular inlet passageway 28. Rotation of the turbine wheel 12 rotates the compressor wheel 16 (via the shaft 18) which draws in air through an axial inlet 30 and delivers compressed air to an engine intake (not shown) via an annular outlet volute 32.

The turbocharger shown in and described with reference to FIG. 1 may be used, for example, in a turbocompound engine system. FIG. 2 schematically depicts an example of a turbocompound engine system. The turbocompound engine system comprises the turbocharger 2 shown in and described with reference to FIG. 1. Referring back to FIG. 2 the turbocharger 2 is connected to an engine 34. The connection is such that exhaust gas exiting an outlet manifold 38 is used to drive the turbine wheel of the turbine 4 of the turbocharger 2. Such rotation causes the compressor wheel of the compressor 6 to draw in air 40 and compress it, such that compressed air 41 may be delivered to an engine intake manifold 42.

The turbine 4 is a gas expander. As known in the art, this means that gas expansion within the turbine 4 allows mechanical work to be derived from rotation of the turbine wheel within the turbine. In the case of a turbine 4 provided with a turbine wheel, expansion of the exhaust gas 36 in the turbine 4 causes rotation of the turbine wheel and therefore rotation of the shaft 18.

After causing rotation of the turbine wheel, the exhaust gas 43 leaves the turbine 4. In some applications, this exhaust gas 43 may then be vented to atmosphere, for example via the exhaust pipe of an automobile. However, in order to increase the efficiency of such an automobile (or other machine incorporating such a turbocharger) the exhaust gas 43 may be passed through another gas expander in order to derive further mechanical work from the exhaust gas 43. In this example, the exhaust gas 43 is passed into a gas expander in the form of an additional turbine 44. Since, in this example, the gas expander is a turbine 44, and power is derived from that turbine 44, it is common to refer to the turbine 44 as a power turbine. As is the case in the turbocharger described previously, when the exhaust gas 43 enters into the additional turbine 44 the gas 43 expands and causes rotation of a turbine wheel. Rotation of the turbine wheel causes rotation of an additional shaft 46 to which the turbine wheel is connected. Exhaust gas 48 leaving the additional turbine 44 is then vented to atmosphere, for example by way of an exhaust pipe or the like.

Rotation of the additional shaft 46 may be used, for example, to transmit power to a hydraulic, electrical or mechanical system (or, generically speaking, a load 50). For example, the load may be a crank shaft of the engine 34. Although it may be possible to transmit power directly from the additional shaft 46 to the load 50, it is more common to transmit the power via a mechanical gear 52 and an output shaft 54. The mechanical gear 52 may be used, for example, to ensure that the output shaft 54 is rotated at a desired speed or rate, and/or may be used to ensure that the rotation of the output shaft 54 is in a certain direction.

FIG. 2 is a relatively simplified representation of an example of a turbocompound engine system. FIG. 3 is a perspective-view schematically depicting a more detailed representation of the turbocompound engine system shown in and described with reference to FIG. 2. The description of FIG. 2 and the reference numerals used in FIG. 2 are equally applicable to the description of FIG. 3, and therefore no further description of FIG. 3 will be undertaken here.

As discussed above, the use of mechanical gears has various associated problems and disadvantages. It is desirable to obviate or mitigate such problems and disadvantages. Such problems and disadvantages are not only applicable to the use of mechanical gears in gas expander systems in a turbocompound engine system, but are applicable to gas expander systems in general, for example in a waste heat recovery system comprising such a gas expander system.

FIG. 4 schematically depicts another example of a turbocompound engine system. The turbocompound engine system is substantially the same as the turbocompound engine system shown in and described with reference to FIG. 2, and therefore like features are given the same reference numerals. The turbocompound engine system of FIG. 4 does, however, include additional gas flow paths and some additional components. For instance, a portion 56 of the gas 36 leaving the engine outlet manifold 38 of the engine 34 may be directed into the engine inlet manifold 40. This is known as exhaust gas recirculation. Alternatively or additionally, a portion 58 of exhaust gas 48 leaving the additional turbine 40 may be directed such that it combines with the intake gas 40 (e.g. air) for the compressor 6 of the turbocharger 2. Again, this is known as exhaust gas recirculation. Exhaust gas recirculation may, for example, improve efficiency of an engine system and/or reduce the level of harmful emissions present in exhaust gases vented to atmosphere turbocompound engine system. FIG. 4 also shows that an engine cooling circuit 60 may be provided for cooling the engine 34. Alternatively or additionally, an engine cooling jacket 62 may be provided for cooling the engine 34.

It has already been described that use of a power turbine may be used to improve the efficiency of an engine by using energy present in an exhaust gas to, for example, power a turbine which in turn transmits power to a crank shaft of the engine. Further gains in efficiency can be achieved by taking advantage of exhaust gas recirculation principles. Still further efficiency gains can be obtained by recovering energy from one or more sources of waste heat within or forming part of the engine system, and using energy extracted from the heat source to power a hydraulic, electrical or mechanical system (e.g. the crank shaft of the engine 34). A system that recovers energy from a source of wasted heat is known as a waste heat recovery system. A suitable source of heat may be found at one of a number of locations in or around the turbocompound engine system. For example, the source of heat may be one or more of the following: the engine 34, the cooling jacket for the engine 62, the cooling circuit for the engine 60, exhaust gas 36 leaving the engine 34, exhaust gas 43 leaving the turbine 4, exhaust gas 48 leaving the additional turbine 44, compressed gas 41 leaving the compressor 6 and being directed towards the engine 34, or the heat present in one or more gas recirculation paths 56, 58.

FIG. 5 schematically depicts a waste heat recovery system. The waste heat recovery system is configured to recover (e.g. extract) energy from wasted heat generated by one or more of the heat sources described above and to convert this heat (or thermal energy) into mechanical work.

Referring to FIG. 5, the waste heat recovery system is a closed loop system 64. The closed loop system 64 is provided with a working fluid (e.g. water, refrigerant, or any other fluid capable of carrying heat). The fluid in the closed loop system 64 is heated by one or more of the heat sources described above, generically denoted by reference numeral 66 in the Figure. The heating may be achieved by, for example, one or more conduits of a closed loop system 64 being in contact with one or more of the heat sources 66, or any other suitable arrangement. Heating of the working fluid causes the working fluid to expand into a gaseous form (e.g. by boiling, evaporation, vaporisation or the like). The heated fluid 68 in gaseous form is allowed to expand in a gas expander 70, for example a turbine comprising a rotatable turbine wheel. Expansion of the heated fluid 68 in the gas expander 70 causes movement of a moveable part of the gas expander (for example a turbine wheel, piston, swash-plate, screw-thread arrangement, or the like). Movement of the moveable part of the gas expander 70 in turn causes movement (e.g. rotation) of a shaft 72 to which the moveable part is connected. The shaft 72 may be connected to an output shaft 74 by way of a mechanical gear 76. The mechanical gear 76 may be used to, for example, ensure that the output shaft 74 moves at the required speed, rate and/or in a desired direction. The output shaft 74 is connected to a load 77, for example an electrical, hydraulic or mechanical load such as a crank shaft of an engine.

A pump 78 forming part of the closed loop system ensures that after expanding in the expander, the working fluid 80 is forced around the closed loop system 64. The fluid is then condensed by a condenser 82 before it is pumped into thermal contact with the heat source 66, completing the closed loop system.

The closed loop system may work in any one of a number of ways and may operate on the basis of the Carnot, Rankine, or Brayton thermodynamic cycles, or any other suitable thermodynamic cycle.

The problems and disadvantages associated with the use of a mechanical gear in a gas expander system (discussed above) are also applicable to the system's shown in FIGS. 4 and 5, since these systems comprise a gas expander provided with a mechanical gear. It is desirable to overcome the problems and disadvantages associated with the use of a mechanical gear in a gas expander system in particular, it is desirable to overcome the problems associated with the use of a mechanical gear which connects a moveable part of a gas expander to a load.

According to embodiments of the present invention, one or more problems or disadvantages associated with the use of a mechanical gear in a gas expander system can be overcome by replacing the mechanical gear with a magnetic gear.

By connecting a moveable part (e.g. a turbine wheel, a piston, a swash-plate, or a screw-thread arrangement) of a gas expander (e.g. a turbine, a piston-type, a swash-plate type, or a screw-type expander) to a load via a magnetic gear arrangement and a shaft, one or more problems associated with the use of mechanical gears as used in existing gas expander systems can be obviated or mitigated. For instance, in comparison with mechanical gears, magnetic gears require reduced maintenance and offer improved reliability. Magnetic gears are lubrication free in some embodiments, and in other embodiments require less lubrication than mechanical gears. Magnetic gears are more efficient than conventional mechanical gears. Magnetic gears offer precise peak torque transmission and inherent overload protection (e.g. the magnetic gears are not damaged when an excessive force is applied to the magnetic gear which would, in mechanical gears, cause damage to teeth of the gears). The use of the magnetic gear may allow the physical isolation between an input and an output shaft, and this can be taken advantage of as described in more detail below. Magnetic gears offer inherent anti-jamming transmission and significantly reduce harmful drive-train pulsations. Furthermore, magnetic gears allow for misalignment of for example, input and output shafts of a gas expander system. Finally, magnetic gears have very low acoustic noise and vibration associated when in use, at least in comparison with mechanical gears.

Specific embodiments of the present invention will now be described, by way of example only, with reference to FIGS. 6 to 25.

FIGS. 6 and 7 schematically depict one example of a magnetic gear. FIG. 6 schematically depicts an end-on view of the magnetic gear, and FIG. 7 schematically depicts a perspective view of the magnetic gear. FIGS. 6 and 7 will be referred to in combination.

The magnetic gear comprises a first member in the form of an inner rotor 84 and a second member in the form of an outer rotor 86. Located in-between the inner rotor 84 and outer rotor 86 is a stator 88. The inner rotor 84, stator 88 and outer rotor 86 are all shaped like a hollow cylinder (that is, a cylinder with a bore extending through the entire length of the cylinder), and are concentrically arranged with respect to one another. In another example, the inner rotor 84 may not be shaped like a hollow cylinder, but may instead be shaped like a cylinder.

In this embodiment, the inner rotor 84 and outer rotor 88 are rotatable, whereas the stator 88 remains fixed in position. One or more bearings or the like (not shown in FIG. 6 or 7) may be located in-between the inner rotor 84 and the stator 88 and/or between the stator 88 and the outer rotor 86.

The inner rotor 84 and the outer rotor 86 are both provided with a plurality of permanent magnets 90 located in, or mounted in, spacing material 91. The permanent magnets 90 are spaced apart and extend around the inner rotor 84 and the outer rotor 86, respectively. The permanent magnets 90 also extend along the length of the inner rotor 84 and the outer rotor 86, respectively. The permanent magnets 90 may be, for example, rare-earth permanent, magnets. The stator 88 is provided with a plurality of ferromagnetic pole-pieces 92 located in, or mounted in, spacing material 93. The pole-pieces 92 are spaced apart and extend around the stator 88. The pole-pieces 92 also extend along the length of the stator 88.

By providing the magnets and 90 and pole-pieces 92 in one or more particular configurations (e.g. by choosing appropriate numbers, spacings, distributions, and the like, of the magnets 90 and/or pole pieces 92) rotation of the inner rotor 84 can be made to cause rotation of the outer rotor 86. Similarly, rotation of the outer rotor 86 can be made to cause rotation of the inner rotor 84. The configuration of the permanent magnets 90 and/or pole pieces 92 can be chosen to ensure that there is a specific ratio between the rate of rotation of the inner rotor 84 and outer rotor 86—i.e. to form a gear. The gear ratio may be any suitable ratio, For a given arrangement or configuration of the permanent magnets 90 and/or pole pieces 92, the magnetic gear arrangement will have an inherent and fixed gear ratio.

Operation of the magnetic gear depends on the modulation of the magnetic fields provided by each of the permanent magnets 90 of the inner and outer rotors 84, 86 by the ferromagnetic pole-pieces 92 of the stator 88. The modulation should result in appropriate harmonics (in the magnetic flux density distribution) with the requisite number of poles as the associated permanent magnetic gear rotor in question. More details of the functionality, operation and design of magnetic gears can be found in, for example, “Design, analysis and realisation of a high-performance magnetic gear, by K. Atallah, S. D. Calverley and D. Howe, IEE Proc.—Electr. Power Appl., Vol. 151, No. 2, March 2004”, and also in “High-performance magnetic gears, by Kais Atallah, Stuart D. Calverley, David Howe, Journal of Magnetism and Magnetic Materials 272-276 (2004) e1727-e1729” and publications by Magnomatics™.

FIG. 8 is a section-view of a gas expander system in accordance with an embodiment of the present invention. The gas expander system comprises a gas expander in the form of a turbine 94 which is connected, via an input shaft 96, a magnetic year 98, and an output shaft 100, to a load 102 in the form of an output gear 102.

The turbine 94 is similar to the turbine discussed above. The turbine 94 comprises an annular fluid inlet 104. Fluid flowing through the inlet 104 rotates a turbine wheel 106 which is connected to the input shaft 96. Fluid which has caused rotation of the turbine wheel 106 leaves the turbine via an outlet 108.

The fluid used to rotate the turbine wheel 106 will depend on the application of the gas expander system. In one example, the fluid may be exhaust gas from an engine, or exhaust gas leaving a turbine of a turbocharger or the like. In another example, the fluid may be the working fluid of a closed-loop waste heat recovery system. Such different applications will be discussed in more detail below.

The input shaft 96 extends from the turbine wheel 106 and into connection with an inner rotor 84 of the magnetic gear 98. Rotation of the turbine wheel 106 thus causes rotation of the input shaft 96, which in turn causes rotation of the inner rotor 84 of the magnetic gear 98.

As discussed above, rotation of the inner rotor 84 of the magnetic gear 98 is will cause rotation of an outer rotor 86 of the magnetic gear 98 (i.e. torque can be transmitted from the inner rotor 84 to the outer rotor 86). The outer rotor 86 of the magnetic gear is attached to the output shaft 100. Thus, rotation of the outer rotor 86 causes rotation of the output shaft 100, and this allows power to be transmitted to the load in the form of output gear 102.

The stator 88 of the magnetic gear 98 may be located in, or form part of a wall 108. The wall 108 separates a housing 110 of the turbine 94 from a housing 112 of the magnetic gear 98 and (at least a part of) the output shaft 100. Such separation may be taken advantage of as will be discussed in more detail below.

In addition to the components already described, the gas expander system may also be provided with additional components. Referring back to FIG. 8, the gas expander system may be provided with one or more bearings 114 for supporting the output shaft 100. The gas expander system may also be provided with one or more bearings 116 for supporting the input shaft and/or inner rotor 84 of the magnetic gear 98 to which the input shaft 96 is connected. One or more lubrication inlets 118 and lubrication channels 120 may be provided for lubrication of, for example, the bearings 116 supporting the input shaft 96. A lubricant drain 122 may also be provided to allow lubricant to leave the gas expander system.

The gas expander system of FIG. 8 may be used in a wide variety of applications, and in particular in a turbomachine (i.e. a machine provided with a turbocharger). A turbomachine incorporating the gas expander system of FIG. 8 may be made to operate more efficiently.

FIG. 9 schematically depicts one application of the gas expander system shown in and described with reference to FIG. 8, in accordance with an embodiment of the present invention. In general, FIG. 9 schematically depicts substantially the same turbocompound engine system shown in and described with reference to FIG. 2. As a consequence of this, like features appearing in FIG. 9 have been given the same reference numerals as they were given in the description of FIG. 2. In stark contrast to the turbocompound engine system shown in and described with reference to FIG. 2, however, the turbocompound engine system described with reference to FIG. 9 is provided with the gas expander system 124 as shown in and described with reference to FIG. 8.

The gas expander system 124 forms the power turbine of the turbocompound engine system. Exhaust gas 43 leaving the turbine 4 of the turbocharger 2 is used to rotate the turbine wheel of the turbine 94 forming part of the gas expander system 124. Rotation of the turbine wheel of the turbine 94 causes power to be transmitted to the load 102 via appropriate rotation of the input shaft 96, rotation of the inner and outer rotors of the magnetic gear 98 and rotation of the output shaft 100. A significant difference between the turbocompound engine system shown in FIG. 9 and that shown in and described with reference to FIG. 2 is that, in FIG. 9, the gear 98 connecting the turbine wheel of the turbine 94 to the load 102 is magnetic, and not mechanical, in nature. The turbocompound engine system as shown in and described with reference to FIG. 9 thus takes advantage of all the benefits associated with the use of a magnetic gear, as opposed to the use of a mechanical gear, as discussed above.

FIG. 10 schematically depicts another application of the gas expander system of FIG. 8, according to an embodiment of the present invention. FIG. 10 schematically depicts a waste heat recovery system that is, in general, substantially the same as the waste heat recovery system shown in and described with reference to FIGS. 5 and 4. Thus, the description of the waste heat recovery system of FIG. 5, described in relation to the turbocompound engine system of FIG. 4, is equally applicable to the description of the waste heat recovery system of FIG. 10. However, in contrast with the waste heat recovery system shown in FIG. 5, the waste heat recovery system of FIG. 10 is provided with the gas expander system 124 shown in and described with reference to FIG. 8. That is, fluid flowing around and expanding within the closed loop system 64 is used to cause rotation of the turbine wheel within the turbine 94 of the gas expander system 124. As described above, the gas expander system 124 transmits power to the load 102 via an input shaft 96, a magnetic gear 98 and an output shaft 100. By using the magnetic gear 98 in the waste heat recovery system, the waste heat recovery system does not have associated with it the disadvantages usually associated with the use of one or more mechanical gears, as discussed above.

Referring back to FIG. 8, it was described that the stator 88 may be, form part of, or be located within or on a wall 108 which separates the turbine housing 110 from the housing 112 of the magnetic gear 98 and (at least a part of) the output shaft 100. In some embodiments, this arrangement may not be required. In other embodiments, however, this arrangement may be advantageous. FIG. 11 schematically depicts, in general, the same waste heat recovery system that is shown in and described with reference to FIG. 10. In the embodiments shown in FIG. 11, however, the stator 88 of the magnetic gear 94, which is located in the wall 108, is shown as forming part of a wall or enclosure that encloses the closed loop system 64. By locating the stator 88 in a wall 108 which is or forms part of a wall 126 of a closed loop system 64 of the waste heat recovery system, the working fluid of the waste heat recovery system, cannot escape—i.e. there is no opening in the wall 108 through which the working fluid map pass. Despite there being no opening in the wall 108, due to the fact that magnetic flux can pass through solid objects, power derived from rotation of the turbine wheel of the turbine 94 can be transmitted across the wall 126 of the closed loop system 64 via the use of the magnetic gear 98.

FIG. 12 schematically depicts an expanded view of a part of the system of FIG. 11. FIG. 12 shows the magnetic gear 98 in relation to the wall 126 of the closed loop system of the waste heat recovery system. The location of the stator 88 can be more clearly seen in this expanded view.

Although the use of magnetic gears is advantageous, for example in comparison with mechanical gears, the use of magnetic gears may still have associated problems. It is desirable to eliminate or reduce these problems or the effects of these problems. In one example, rotation of the inner and/or outer rotors of the magnetic gear may cause heat to be generated within the magnetic gear (e.g. 500 W). It is desirable to remove this heat from the magnetic gear to, for example, prevent overheating of the magnetic gear and/or undesirable expansion of component parts of the magnetic gear which could cause the magnetic gear to malfunction or cease to operate.

According to an embodiment of the present invention, the magnetic gear may be cooled by passing air through/or around component parts (i.e. members) of the magnetic gear. In principle, air could be directed in and/or around the magnetic gear using an air flow that is already present in or around the magnetic gear, for example due to motion of the machine in which the magnetic gear is present. Preferably, however, cooling of the magnetic gear should not be linked to such external criteria (e.g. movement of the machine in which the gear is located). This independence can be achieved by providing one or more rotors of the magnetic gear with an impeller configured to push air in and/or around the members of the magnetic gear. The impeller may be, for example, attached to, or form part of an inner or outer rotor of the magnetic gear. Preferably the magnetic gear and impeller arrangement is configured, to ensure that, in general, air is directed away from an axis of rotation of the inner or outer rotor such that heat is not pushed towards the center of the magnetic gear, but is instead pushed out and away from the magnetic gear. Specific embodiments of the application of the impeller for cooling the magnetic gear will now be described. The same or similar effect can be achieved by providing one or more members of the magnetic gear with apertures or a surface profile which encourages such air flow upon rotation of the respective member.

FIG. 13 schematically depicts an end-on view of a magnetic gear 128. As with the magnetic gears shown in and described with reference to previous Figures, the magnetic gear 128 of FIG. 13 comprises an inner rotor 130, a stator 132 and an outer rotor 134. The inner rotor 130, stator 132 and outer rotor 134 are arranged concentrically about a common longitudinal axis 136. The inner rotor 130, stator 132 and outer rotor 134 all have a hollow-cylinder shape, the cylinders extending along the longitudinal axis 126. Spaces 138 are formed between the inner rotor 130 and the stator 132, and also between the stator 132 and the outer rotor 134. One or more bearings may be located in the spaces 138.

FIG. 14 shows an example of an impeller 140 that may be attached to, or formed as part of one of the rotors of the magnetic gear. It can be seen that the impeller 140 has a substantially annular shape. The impeller may be formed from any suitable material, and may be formed from the same material that forms part of the rotor of the magnetic gear.

FIG. 15 shows how the impeller 140 may be located relative to the magnetic gear 128. The impeller 140 is attached to an end of the inner rotor 130, and such that the impeller 140 extends radially across a space formed between the inner rotor 130 and the stator 132. Upon rotation of the inner rotor 130, the impeller 140 is configured to draw air into the magnetic gear and along and through the space between the inner rotor 130 and the stator 132. Depending on the arrangement of the magnetic gear 128 and, for example, a housing of the magnetic gear 128, air may not simply flow along the magnetic gear in the space between the inner rotor 130 and the stator 132 and then leave the gear 128. Instead, the air may then be redirected back through the magnetic gear in an opposite direction, along and through the space 138 located in-between the stator 132 and the outer rotor 134. Furthermore, the air may then be redirected again along an outer surface of the outer rotor 134.

If the air is made to flow in this serpentine-like manner, the air will pass along the inner rotor 130, stator 132 and outer rotor 134, cooling these members. Furthermore, the air is, in general, flowing radially away from the longitudinal axis 136 of the magnetic gear, thus ensuring that heated air is not pushed towards the center of the magnetic gear, but is instead pushed out and away from the magnetic gear

FIGS. 14 and 15 show an impeller may be used to cause a flow of air in and around the members of the magnetic gear. In other embodiments, one or more members of the magnetic gear may be provided with apertures or a surface profile which encourages such air flow. For example, FIG. 16 shows how a rotor 142 of the magnetic gear (for example an inner or outer rotor) can be provided with surface profiling in the form of rifling 144. As with the impeller embodiment described above, rotation of the rotor 142 will cause rotation of the rifling 144 which will, in turn, induce an air flow along the rotor 142 in a direction dependent on the direction of rotation of the rotor 142. The rifling 144 (or other surface profile) may be provided on an inner or outer surface of the rotor, or on both surfaces.

As described above, an advantage of providing one or more rotors of the magnetic gear with, apertures, surface profiling and/or an impeller, is that the magnetic gear provides its own flow of air. A further advantage is that the flow rate of the air increases as the rotation of, for example, the rotor increases. This means that as the rotor gets hotter due to increased rotation, the rate of flow of cooling air also increases to counteract the heating effect. Therefore, not only is the embodiment useful for providing self-sufficient cooling, but the self-sufficient cooling is, at least to some extent, tailored to the speed rotation of members of the magnetic gear and thus the heating of the magnetic gear.

FIG. 17 schematically depicts a side-on section view of the magnetic gear and impeller arrangement of FIG. 14 in-situ relative to an input shaft and output shaft (for example of a gas expander system). The inner rotor 130 of the magnetic gear is shown as being connected to an input shaft 146 via a hub 148. The impeller 140 is shown as being attached to an end of the inner rotor 130. The stator 132 and the outer rotor 134 are shown as surrounding, in a concentric manner, the inner rotor 130, as described above. The outer rotor 134 is attached to an output shaft 150. As discussed above, in relation to previous embodiments, rotation of the input shaft 146 (for example, by a turbine wheel connect to the input shaft 146) causes rotation of the inner rotor 130. Rotation of the inner rotor 130 causes, in turn, rotation of the outer rotor 134 and the output shaft 150 to which the outer rotor 134 is attached. The input shaft 146, inner rotor 130, outer rotor 134 and output shaft 150 all have a common axis of rotation 136.

Rotation of the input shaft 146 causes rotation of the inner rotor 130 and the impeller 140, which is attached to the inner rotor 130. Rotation of the impeller 140 causes air 152 to be drawn into the space 138 between the inner rotor 130 and the stator 132. Air flows along this space 138. When the air 152 reaches the opposite end of the inner rotor 130, it impinges against and is directed by a housing 154 of the outer rotor 134. The air 152 is directed away from the longitudinal axis 136 and, due to the shape of the housing 154, is then directed between a space 138 in-between the stator 132 and the outer rotor 134. When the air 152 reaches the opposite end of the outer rotor 134, it is redirected by at least one of a stator housing 156, an input shaft housing 158 and/or a magnetic gear housing 160, such that the air 152 is then directed along an outer surface of the outer rotor 134 and/Or outer rotor casing 154 and out through one or more vents 162 provided in the magnetic gear housing 160.

It can be seen from the Figure that the air flow path is serpentine in nature. The path that the air flow 152 takes after being drawn into the magnetic gear by the impeller 140 leads around the members of the magnetic gear before leaving the magnetic gear housing 160. Furthermore, and in an advantageous manner as described above, the direction of the flow of air 152 is, in general, radially away from the axis of rotation 136 of the members of the magnetic gear.

FIG. 18 schematically depicts an end on view of a magnetic gear. The magnetic gear is the same as the magnetic gear shown in and described with reference to FIG. 6. Therefore, like features appearing in both Figures have been given like reference numerals. FIG. 18 shows that if the inner rotor 84 is rotated in a first direction (e.g. clockwise in the Figure) then the outer rotor 86 will rotate in the opposite direction (e.g. anti-clockwise in the Figure). It will be appreciated that if the outer rotor 86 is rotated in one direction (e.g. anti-clockwise in the Figure) the inner rotor 84 will rotate in the opposite direction (e.g. clockwise in the Figure). It will thus be appreciated that rotation of the inner rotor can be transmitted to rotation of the outer rotor (i.e. torque can be transmitted in a first direction), and rotation of the outer rotor can be transmitted to rotation of the inner rotor (i.e. torque can be transmitted in a first direction). In some applications, this is not desirable.

In previous embodiments, the inner rotor 84 of the magnetic gear has been described as being attached to or forming part of an input shaft that may be attached to, for example a moveable part of a gas expander. The moveable part may be, for example a turbine wheel of a turbine. Rotation of the turbine wheel will cause rotation of the input shaft, and corresponding rotation of the inner rotor 84. Rotation of the inner rotor 84 will cause rotation of the outer rotor 86. As discussed in previous embodiments, the outer rotor 86 may be attached to a load, for example an engine crank shaft, or an output shaft or one more gears or the like. Thus, rotation of the outer rotor 86 can be used to transmit power to the load. This situation is desirable, since exhaust gases which would otherwise be vented to atmosphere can be used to drive the turbine, cause rotation of the members of the magnetic gear, which in turn transmits power to the engine crank shaft. Thus, the efficiency of the machine in incorporating the gas expander is increased, since exhaust gases are no longer simply being vented to atmosphere, but instead being used to provide power to the engine crank shaft.

As discussed above, the magnetic gear will be connected to a load. In some circumstances, for example when the load is an engine crank shaft, the load itself may cause rotation of the outer rotor 86 of the magnetic gear. This will cause rotation of the inner rotor 84 of the magnetic gear which will in turn cause rotation of the turbine wheel. This may be described as negative torque. If the flow of exhaust gas about the turbine wheel is not great enough to provide sufficient ‘positive’ torque to overcome the negative torque, the efficiency of the system is decreased. This is because the engine crank shaft will be driving the turbine wheel in some circumstances, rather than the rotation of the turbine wheel driving the crankshaft. It is therefore desirable to provide a de-clutching mechanism which, in some circumstances, prevents rotation of the outer rotor of the magnetic gear causing rotation of the inner rotor of the magnetic gear. In other words, it is therefore desirable to provide a de-clutching mechanism which prevents negative torque transmission.

The operation of the magnetic gear shown in FIG. 18 is similar to that of an epicyclic gear box. In such an epicyclic gear box, by allowing the stator of the gear to freely rotate (or in other words free wheel) no torque can be transmitted from the inner rotor to the outer rotor, or from the outer rotor to the inner rotor. According to an embodiment of the present invention, by allowing the stator 88 of the magnetic gear to freely rotate (or in other words free wheel) no torque can be transmitted from the inner rotor 84 to the outer rotor 86, or from the outer rotor 86 to the inner rotor 84.

It will be understood that, in normal terminology, a stator is a component that does not move. The stator does not move in many of the embodiments described herein. However, in order to keep the description of the Figures consistent, the stator is sometimes described herein as being moveable. When the stator is prevented from moving, it once again serves as a stator in the true sense of the word. In this context, the stator may thus be generically described as a magnetic gear member located in-between a first (e.g. inner) rotor of a magnetic gear and a second (e.g. outer) rotor of a magnetic gear.

This magnetic gear member may be moveable or be fixed in position. However, for the remainder of this description, the term ‘stator’ will be used for consistency and to avoid confusion, since a magnetic gear member located in-between a first (e.g. inner) rotor of a magnetic gear and a second (e.g. outer) rotor of a magnetic gear is commonly referred to as a stator.

FIG. 19 shows the same magnetic gear that was shown in and described with FIGS. 18 and 6. However, in FIG. 19, the stator 88 is no longer being maintained in a fixed position, but is allowed to rotate freely. FIG. 19 shows that when the stator 88 is allowed to freely rotate, rotation of the outer rotor 86 causes rotation of the stator 88, but does not cause rotation of the inner rotor 84. FIG. 20 shows the same magnetic gear. However, in FIG. 20, the inner rotor 84 is shown as rotating, and causing rotation of the freely rotatable stator 88. Again, no torque is transmitted to the outer rotor 86.

The stator may be allowed to rotate around or about one or more bearings. When it is desirable to prevent torque transmission between the inner rotor 84 and the outer rotor 86, the stator 88 can be allowed to freely rotate by, for example, appropriate engagement or disengagement of an actuator or the like. The actuator may lock into position in the stator 88 to prevent rotation of the stator 88 when such rotation is not required.

An engine management system or the like may detect when torque transmission is ‘positive’ (i.e. from the turbine to the engine crank shaft) or ‘negative’ (from the engine crank shaft to the turbine wheel). When negative transmission of torque is detected, the stator 88 may be put into a free-wheeling state.

In some embodiments, detection and active actuation of the free-wheeling state of the stator may not be required. For instance, any commonly known freewheeling-mechanism may be applied to the magnetic gear arrangement to prevent negative torque transmission. One freewheel mechanism consists of two saw-toothed, spring-loaded discs pressing against each other with the toothed sides together, somewhat like a ratchet. Rotating in one direction, the saw teeth of the drive disc lock with the teeth of the driven disc, making it rotate at the same speed. If the drive disc slows down or stops rotating, the teeth of the driven disc slip over the drive disc teeth and continue rotating. The discs may form part of, or be attached to, appropriate parts of the magnetic gear such as the stator and outer rotor. Alternatively, the teeth may form part of the stator and outer rotor. The stator may be allowed to freewheel only in one direction, for example when the torque transmission is negative and the teeth engage with one another.

Other arrangements for preventing torque transmission between the inner and outer rotor of a magnetic gear are also possible. Such arrangements will now be discussed in relation to FIGS. 21 to 23.

FIG. 21 schematically depicts, in an end-on view, a magnetic gear in accordance with an embodiment of the present invention. As described above in previous embodiments, the magnetic gear comprises an inner rotor 164. Surrounding the inner rotor 164 is a stator 166. Surrounding the stator 166 and the inner rotor 164 is an outer rotor 168. The inner rotor 164, stator 166 and outer rotor 168 all have a hollow cylinder shape and are arranged concentrically with respect to one another. The inner rotor 164 and outer rotor 168 comprise, as discussed above, permanent magnets 170. In a similar manner to the stator as described above, the stator 166 of the magnetic gear of FIG. 21 is provided with ferromagnetic pole-pieces 172.

In contrast with the magnetic gears discussed above, where, in terms of its overall shape, the stator forms a single-piece hollow cylinder, the stator 166 of the magnetic gear of FIG. 21 comprises two concentrically arranged stator members: an inner stator member 174 and an outer stator member 176. At least one of the inner stator member 174 and outer stator member 176 is selectively moveable relative to the other stator member.

The inner stator member 174 and outer stator member 176 are each provided with a plurality of pole-pieces 172 which are equally spaced apart and extend around each respective stator member 174, 176. The pole-pieces 172 of the inner stator member 174 and outer stator member 176 are arranged such that the pole-pieces 172 of the inner stator member 174 can be brought into or moved out of alignment with the pole-pieces 172 of the outer stator member 176.

FIG. 21 shows the situation wherein the pole-pieces 172 of the inner stator member 174 are in direct alignment with the pole-pieces 172 of the outer stator 176. In this situation, the inner stator member 174 and outer stator member 176 form and function as a single stator member, for example the single stator discussed above in relation to previous embodiments. When the inner stator member 174 and outer stator member 176 are in the configuration shown in FIG. 21, and when both the inner stator member 174 and outer stator member 176 are prevented from rotating, the magnetic gear shown in FIG. 21 functions in the same way as shown in and described above in relation to previous embodiments. For instance, torque may be transmitted from the outer rotor 168 to the inner rotor 164, or from the inner rotor 164 to the outer rotor 168.

FIG. 22 shows a situation wherein the inner stator member 174 has been rotated by an angle θ relative to its position in FIG. 21 and relative to the outer stator 176. The angle θ is chosen such that the pole-pieces 172 of the inner stator member 174 are no longer in direct alignment with the pole-pieces 172 of the outer stator member 176. The angle θ is chosen such that the pole-pieces 172 of the inner stator member 174 align with spaces in-between the pole-pieces 172 of the outer stator member 176.

As discussed above, rotation of an inner rotor of a magnetic gear can only cause rotation of an outer rotor of a magnetic gear if the magnetic flux density or densities have a specific configuration which enables such rotation to be transmitted between the rotors. When the stator 166 of the magnetic gear has the configuration shown in FIG. 22, magnetic flux from the inner rotor 164 cannot be transmitted to the outer rotor 168, and magnetic flux from the outer rotor 168 cannot be transmitted to the inner rotor 164. Thus, when the stator 166 is in the configuration shown in FIG. 22, the rotors 164 and 168 are de-clutched from one another.

Movement of one or both of the inner and outer stator members 174, 176 may be achieved in any one of a number of ways. Preferably, only one of the stator members 174, 176 is moveable to limit the complexity and costs of any arrangement used to move one of the stator members and to reduce the chances of malfunction in the arrangement, and also to reduce the complexity, costs and chances of malfunction of the stator 166 itself. One or both of the stator members 174, 176 may be moved by, for example, a motor. Preferably this may be accomplished using a non-backdrive mechanism such as a lead-screw, so that energy only needs to be used to move one of the stator members 174, 176 and not to keep one or both of the stator members 174, 176 in a desired position.

Another approach to controlling the arrangement of the inner and/or outer stator members 174, 176 would be to allow only one of the stator members 174, 176 to be freely moveable. The freely moveable stator member may be arranged such that it is selectively rotated in a given direction by the magnetic forces present within the magnetic gear, and in a direction in which torque was being transmitted through the magnetic gear. For example, the inner rotor 174 could be rotatably mounted. The rotatable mounting might allow rotation of the inner stator member 174 in only a certain direction, for example by providing a stop or the like which prevents the inner stator member 174 from rotating in the opposite direction. The direction in which rotation of the inner stator member 174 is allowable may correspond to the direction in which the stator member would move if the torque transmission through the gear was negative, i.e. from the outer rotor 168 to the inner rotor 164. At the point at which negative torque transmission occurs, the inner stator 174 member would (in a passive manner, i.e. without any active input) be dragged into a position shown in and described with reference to FIG. 22, thereby preventing torque being transmitted from the outer rotor 168 to the inner rotor 164, automatically de-clutching the magnetic gear.

FIG. 23 depicts another embodiment of a magnetic gear in accordance with an embodiment of the present invention. The magnetic gear comprises the same constituent parts as shown in and described with reference to FIGS. 6 and 7, and therefore the like features appearing in FIGS. 6 and 7 have been given the same reference numerals in FIG. 23. In summary, the magnetic gear of FIG. 23 comprises of an inner rotor 84, a stator 88 which surrounds the inner rotor 84 and an outer rotor 86 which surrounds both the stator 88 and the inner rotor 84.

Referring back to FIGS. 6 and 7, the stator 88 was described as being fixed in position. Referring back to FIG. 23, in contrast the stator 88 is now actively moveable in an axial direction as indicated by the arrows in the Figure. When the stator 88 is located substantially between the inner rotor 84 and the outer rotor 86, torque transmission is possible between the inner rotor 84 and the outer rotor 86. This is due to the appropriate modulation of the magnetic flux density by the pole-pieces of the stator. However, when the stator 88 is substantially and axially withdrawn from its location in-between the inner rotor 84 and outer rotor 86, the magnetic flux density is no longer modulated to allow torque to be transmitted between the inner rotor 84 and the outer rotor 86. Thus, by substantially and axially withdrawing the stator 88, a de-clutching mechanism is achieved.

The stator 88 may be axially moved in any one of a number of ways. For instance, one or more actuators may be used to selectively push and/or pull the stator into or out of a location in-between the inner rotor 84 and the outer rotor 86.

The embodiments discussed above in relation to FIGS. 18 to 23 have shown how torque transmission can be prevented between the inner and outer rotors of a magnetic gear. All of the embodiments have advantages, as described in relation to each respective embodiment. However, it is envisaged that the embodiment shown in and described with reference to FIGS. 18-20 may be preferable. This is because this embodiment, which relies on allowing the stator to be freely rotatable, does not require axial movement of the stator (which might require more space within a machine in which the magnetic gear is used), and does not require the stator to be formed from two separate parts (which can be more expensive and lead to complications in terms of construction, maintenance and operation of the magnetic gear). A further possible advantage associated with the free-wheel stator embodiment shown in and described with reference to FIGS. 18 to 20 is that the free-wheeling stator can be used to drive a generator or dynamo (or any other electricity generation arrangement), such that the electrical energy may be extracted from rotation of the free-wheeling stator.

All of the embodiments described above have shown a magnetic gear in which the outer rotor, stator and inner rotor are concentrically arranged about a common rotational axis. In those embodiments, the outer rotor at least partially surrounds the stator, which at least partially surrounds the inner rotor.

FIG. 24 schematically depicts this arrangement of the magnetic gear. FIG. 24 schematically depicts a magnetic gear system comprising an input shaft 180 attached to an inner rotor 182. At least partially surrounding the inner rotor 182 is a stator 184. At least partially surrounding the stator 184 is an outer rotor 186. The outer rotor 186 is attached to an output shaft 188. Although the magnetic gear arrangement shown in FIG. 24 has been the magnetic gear arrangement used to describe the embodiments of the invention included above, it is not the only magnetic gear arrangement.

FIG. 25 depicts another magnetic gear arrangement. The magnetic gear arrangement comprises an input shaft 190 attached to a first rotor 192. Disposed between the first rotor 192 and a second rotor 194 is a stator 196. The second rotor 194 is attached to an output shaft 198. The first rotor 192, stator 196 and second rotor 194 are all substantially planar, and in this example are substantially disc-shaped. The embodiments discussed above in relation to the magnetic gear arrangement having the configuration shown in FIG. 24 are applicable to the magnetic gear arrangement shown in and described with reference to FIG. 25. However, it will be appreciated that, in some embodiments, slight modifications may need to be made to the arrangement shown in FIG. 25 to implement embodiments of the present invention discussed above in relation to the arrangement shown in and described with reference to FIG. 24.

With regard to the embodiments shown in and described with reference to FIGS. 9 and 10, the magnetic gear arrangement shown in FIG. 25 could simply be replace the arrangement akin to that shown in FIG. 24.

With regard to the embodiment shown in FIG. 11, the arrangement shown in FIG. 25 could be implement therein by ensuring that the first rotor 192 and second rotor 194 are separated from each other by a wall of a the closed loop system, the stator 196 being part of or being attached to that wall.

FIGS. 13 to 16 described how an impeller could be attached to a rotor of a magnetic gear arrangement as shown in and described with reference to FIG. 24 to cool the magnetic gear arrangement. Such cooling could be implemented with the magnetic gear arrangement shown in and described with reference FIG. 25 by, for example, attaching an impeller to the periphery of the first rotor 192 which is arranged to direct air in-between the first rotor 192 and the stator 196. An additional impeller could be added to the second rotor 194 to, similarly, direct air in-between a second rotor 194 and the stator 196. Rifling or the like could be provided on one or more surfaces of the magnetic gear arrangement shown in FIG. 25 to either draw air toward or away from parts of the arrangement.

The free-wheeling stator embodiments shown in and described with reference to FIGS. 18-20 can be implemented using the magnetic gear arrangement shown in FIG. 25 by the selectively allowing or preventing the stator 196 from rotating.

With regard to the two stator member stator member arrangements shown in and described with reference to FIGS. 21 and 22, this may be implemented using the magnetic gear arrangement shown in the FIG. 25 by forming the disc-like stator from two concentric disk-like stator parts or members. Rotation of one or both of the disc stator members can be used to move pole-pieces of the disc-like members into or out of alignment with one another to selectively allow or prevent magnetic flux being transmitted from the first rotor 192 to the second rotor 194, and/or from the second rotor 194 to the first rotor 192.

FIG. 23 describes axial movement of the stator to prevent flux transmission between the inner rotor and outer rotor of the magnetic gear arrangement. This same effect may be implemented using the magnetic gear arrangement shown in FIG. 25 by radial movement of the stator 196 such that the stator 196 is substantially moved from its location between the first rotor 192 and second rotor 194.

In the above-mentioned embodiments, the gear ratio of the magnetic gear arrangement has a fixed value that is related to the arrangement of pole-pieces and permanent magnets in the magnetic gear arrangement. In some embodiments, however, it can be desirable to be able to vary the gear ratio, or to provide what is known in the art as a continuously variable transmission (CVT).

According to an embodiment of the present invention, an arrangement for varying the gear ratio of a magnetic gear arrangement is provided. The arrangement comprises a first rotor connectable to an input shaft, and a second rotor connected to an output shaft. A magnetic gear member (which may be intermediate to the first and second rotors, or surround the first and second rotors), is drivable at a certain speed by a driving arrangement. The speed of rotation of the magnetic gear member affects the magnetic gear ratio of the magnetic gear arrangement as a whole. The speed and/or direction of rotation of the magnetic gear member (for example, ‘the stator’ as described above) can be used to vary the gear ratio of the magnetic gear arrangement about a nominal gear ratio which would be established if the magnetic gear member was not rotated. Rotation of the magnetic gear member may be achieved by, for example, using a motor to drive the rotation of the magnetic gear member. The motor may be connected to the magnetic gear member by an abutment member that abuts against the magnetic gear member. For example, the abutment member could be a cog or gear or the like.

When the magnetic gear member is arranged to be rotated by the driving arrangement, the magnetic gear arrangement will have a second (e.g. varied) gear ratio that is related to an initial (e.g. first or inherent) gear ratio by the following equation:

[Sₘₘ−S_{fr}]/R=Sₛᵣ

where Sₘₘ is the speed of rotation of the magnetic gear member, S_{fr} is the speed of the rotation of the first rotor, Sₛᵣ is the speed of the rotation of the second rotor, and R is the first, inherent gear ratio of the magnetic gear arrangement.

It will be appreciated from the above-mentioned equation that the gear ratio can be varied about the first, inherent gear ratio of the magnetic gear arrangement by control of the speed of rotation of the magnetic gear member.

FIG. 26 schematically depicts a magnetic gear arrangement. The magnetic gear arrangement comprises a first shaft 200. The first shaft 200 is attached to a first rotor 202 of the magnetic gear arrangement. The first rotor 202 has a cylinder like shape, as discussed above in relation to previous embodiments. Surrounding the first rotor 202 is a magnetic gear member 204. The magnetic gear member 204 has a cylinder like shape, as discussed above in relation to previous embodiments. Surrounding both the first rotor 202 and the magnetic gear member 204 is a second rotor 206 which is connected to a second shaft 208. The second rotor 206 has a cylinder like shape, as discussed above in relation to previous embodiments. A driving arrangement 210 is also provided.

The driving arrangement 210 comprises a motor 212 and a gear 214 which abuts against the magnetic gear member 204 and is arranged to rotate the magnetic gear member 204 upon activation of the motor 212.

The inner rotor 202 and outer rotor 206 are provided with a plurality of permanent magnets. The magnetic gear member 204 is provided with a plurality of pole-pieces. The configuration of the permanent magnets and pole-pieces is such that the magnetic gear arrangement has an inherent gear ratio when the magnetic gear member 204 is not rotated. This means that there is an inherent ratio between the speed of rotation of the first shaft 200 and first rotor 202, and the resulting speed of rotation of the second rotor 206 and second shaft 208. If the magnetic gear member 204 is fixed in position and does not rotate, this gear ratio is fixed. If, however, the driving arrangement 210 is used to drive rotation of the magnetic gear member 204 the gear ratio is changed, and this change depends on the speed of rotation of the magnetic gear member as described above.

FIG. 27 shows another embodiment of the magnetic gear arrangement. The magnetic gear arrangement comprises a first shaft 220. Attached to the first shaft is a first rotor 222. The first rotor 222 is substantially disc-shaped.

A second rotor 224 is provided that is also substantially disc-shaped. The second rotor 224 is attached to a second shaft 226. Disposed between the first and second rotors 222, 224 is a disc-shaped magnetic gear member 228. The magnetic gear arrangement is provided with a driving arrangement 230.

The driving arrangement 230 comprises a motor 232 and a gear 234 which abuts against a peripheral surface of the magnetic gear member 228 and is arranged to rotate the magnetic gear member 228 upon activation of the motor 232.

The first rotor 222 and second rotor 224 are provided with a plurality of permanent magnets. The magnetic gear member 228 is provided with a plurality of pole-pieces. The configuration of the permanent magnets and pole-pieces is such that the magnetic gear arrangement has an inherent gear ratio. This means that there is a specific ratio between the speed of rotation of the first rotor 222 and second rotor 224. If the magnetic gear member 228 is fixed in position and does not rotate, this gear ratio is fixed. If, however, the driving arrangement 230 is used to drive rotation of the magnetic gear member 228, the gear ratio can be varied. The variation in the gear ratio depends on the speed of rotation of the magnetic gear member 228, as discussed above.

FIG. 28 schematically depicts a perspective section-view of a gas expander system according to an embodiment of the present invention. The gas expander system of FIG. 28 incorporates the magnetic gear arrangement 240 shown in and described with reference to FIG. 26.

The gas expander system comprises a turbine 242. The turbine is provided with an inlet 244 and an outlet 246. Fluid flowing through the inlet 244 passes and causes rotation of a turbine wheel 248. The turbine wheel 248 is attached to the first shaft 200. The first shaft 200 is supported by bearings 250.

The first shaft 200 extends towards and is attached to the first rotor 202. Surrounding the first rotor 202 is the magnetic gear member 204. A lip 252 of the magnetic gear member 204 (or a housing of the magnetic gear member 204) engages with the gear 214 of the driving arrangement 210. Surrounding the magnetic gear member 204 is the second rotor 206, which is attached to the second shaft 208. The second shaft 208 is supported by bearings 254.

As discussed above, rotation of the turbine wheel 248 can effect rotation of the second shaft 208 and allow power to be transmitted to a load 256 to which the second shaft 208 is connected.

Rather than taking advantage of the inherent gear ratio of the magnetic gear arrangement, it may be desirable to vary the gear ratio as described above. This may be achieved by causing rotation of the magnetic gear member 204 using the driving arrangement 210. The driving arrangement 210 comprises a motor 212 and a gear 214 which abuts against a peripheral lip 252 or surface of the magnetic gear member 204 (or a housing of that member) and is arranged to rotate the magnetic gear member 204 upon activation of the motor 212.

FIG. 29 schematically depicts a perspective section-view of a gas expander system according to another embodiment of the present invention. The gas expander system of FIG. 29 incorporates the magnetic gear arrangement 260 shown in and described with reference to FIG. 27.

The gas expander system comprises a turbine 262. The turbine is provided with an inlet 264 and an outlet 266. Fluid flowing through the inlet 264 passes and causes rotation of a turbine wheel 268. The turbine wheel 268 is attached to the first shaft 222. The first shaft 222 is supported by bearings 270.

The first shaft 222 extends towards and is attached to the first rotor 222. The second rotor 224 is attached to the second shaft 226. The second shaft 208 is supported by bearings 272. Disposed in-between the first rotor 222 and the second rotor 224 is the magnetic gear member 228. As discussed above, rotation of the turbine wheel 268 can effect rotation of the second shaft 226 and allow power to be transmitted to a load 274 to which the second shaft 226 is connected.

Rather than taking advantage of the inherent gear ratio of the magnetic gear arrangement, it may be desirable to vary the gear ratio as described above.

This may be achieved by causing rotation of the magnetic gear member 228 using the driving arrangement 230. The driving arrangement 230 comprises a motor 232 and a gear 234 which abuts against a peripheral surface or lip of the magnetic gear member 228 (or a housing of that member) and is arranged to rotate the magnetic gear member 228 upon activation of the motor 232.

In the above described embodiments, the gas expander system has been described in relation to a waste heat recovery system and a power turbine. In the case of the waste heat recovery system, the load to which power was transmitted was described as being, for example, a hydraulic or mechanical or electrical system. In the case of the power turbine, the load to which power was transmitted was described as being, for example, an engine crankshaft or the like. These are only one of many examples of the use of the gas expander system of the present invention. In another example, the gas expander system may form part of a turbocharger, the load to which power is transmitted being a compressor wheel of that turbocharger. The magnetic gear arrangement, when used in the turbocharger, may allow physical isolation between the shafts that are respectively attached to a compressor wheel and a turbine wheel is attached. This, as described above, may allow for the gear ratio to be varied, such that the ratio on the speeds of rotation of the turbine wheel and compressor wheel can be set to be at a particular (e.g. desired) value. This may be advantageous when, for example, the compressor wheel and turbine wheel have optimum speeds of rotation which are not achievable using a fixed gear ratio.

FIG. 30 schematically depicts a side-on section view of a turbocharger provided with a magnetic gear arrangement. The turbocharger is provided with a turbine wheel 280. The turbine wheel 280 is attached to a first (e.g. input) shaft 282. The first shaft 282 extends into a bearing housing 284, where the first shaft is supported by bearings 286. The first shaft 282 is attached to a first (inner) rotor 288 of the magnetic gear arrangement. Surrounding the first (inner) rotor 288 is a stator 290 (or in other words, a magnetic gear member) of the magnetic gear arrangement. Surrounding the stator 290 is a second (outer) rotor 292 of the magnetic gear arrangement. The second (outer) rotor 292 is attached to a second (e.g. output) shaft 294. The second shaft 294 is supported by bearings 296 in the bearing housing 284. An end of the second shaft 294 remote from the second rotor 292 is attached to a compressor wheel 298.

Rotation of the turbine wheel 280 causes rotation of the compressor wheel, 298, via appropriate interaction between members of the magnetic gear arrangement as described above.

The turbocharger of FIG. 30 may be modified to include one or more of the gas expander embodiments described above.

The embodiments described above have been described in relation to the use of a magnetic gear and a gas expander in a gas expander system. The gas expander system may be used in any suitable environment, for example, in a waste heat recovery system, or a system in which it is desired to extract energy from a flowing and expanding fluid. The embodiments described above, however, are particularly applicable to turbocharger systems (i.e. a system comprising turbocharger) comprising such a gas expander, and in particular those systems that comprise or form part of internal combustion engine systems or motor vehicles. This is because, as discussed above, the use of a magnetic gear in a gas expander system offers improvements in reliability, maintenance, performance and efficiency. These improvements are particularly advantageous in the field of turbocharger systems, and in particular turbocharged motor vehicles and internal combustion engine systems, where there is a constant drive to improve reliability, performance and efficiency and reduce maintenance requirements.

It will be appreciated that a wide range of modifications and alterations may be made to the embodiments of the invention described hereinbefore without departing from the scope of the invention as defined by the claims that follow.

1. A gas expander system suitable for use in a turbomachine, the gas expander system comprising:
a gas expander provided with a moveable part;
a magnetic gear arrangement; and
a shaft;
the moveable part of the gas expander being connectable to a load via the magnetic gear arrangement and the shaft, and movement of the moveable part of the gas expander being arranged to cause movement of the shaft.

2. A turbocharger system comprising:
a turbocharger, comprising a turbine and a compressor;
the gas expander system of claim 1.

3. The system of claim 2, wherein the system is arranged such that a gas flowing into or out of the turbocharger or the gas expander is arranged to cause movement of the moveable part of the gas expander.

4. The system of claim 2, wherein the system comprises a source of heat.

5. The system of claim 4, wherein the source of heat is provided by a part of the turbocharger system, an engine to which the turbocharger is connected, or a fluid flowing into or out of the turbocharger or the engine.

6. The system of claim 4 wherein the source of heat is arranged to heat a working fluid provided in a closed-loop system and cause expansion of that working fluid.

7. The system of claim 6, wherein expansion of the working fluid into a gaseous form in the closed loop system is arranged to move the moveable part of the gas expander.

8. The system of claim 7, wherein the moveable part of the gas expander is located within the closed loop system.

9. The system of claim 6, wherein the magnetic gear comprises a first rotor and a second rotor, the first rotor and second rotor being separated from one another by at least a part of a wall forming part of the closed loop system.

10. The system of claim 9, wherein the at least a part of a wall forming part of the closed loop system that separates the first rotor from the second rotor comprises a stator of the magnetic gear.

11. The system of claim 2, further comprising an impeller arranged to induce a fluid flow through the magnetic gear arrangement.

12. The system of claim 11, wherein the impeller is attached to or forms part of a rotor of the magnetic gear arrangement.

13. The system of claim 2, wherein one or more members of the magnetic gear arrangement is provided with surface profiling or apertures configured to induce a fluid flow through the magnetic gear arrangement.

14. The system of claim 13, wherein the surface profile comprises rifling.

15. The system of claim 11, wherein the fluid flow through the magnetic gear arrangement is, in general, arranged to be directed radially away from an axis about which one or more members of the magnetic gear arrangement is configured to rotate.

16. The system of claim 11, wherein the fluid flow through the magnetic gear arrangement is configured to have a serpentine like path through the magnetic gear arrangement, such that the fluid passes along one or more surfaces of two or three members of the magnetic gear arrangement.

17. The system of claim 16, wherein a housing or casing of one or more members of the magnetic gear arrangement is configured to direct the flow of air in the serpentine like path.

18. The system of claim 2, wherein the magnetic gear arrangement comprises a first rotor, a second rotor, and a magnetic gear member, and wherein the magnetic gear member is rotatable.

19. The system of claim 18, wherein the magnetic gear member is selectively allowed to freewheel.

20. The system of claim 18, wherein the system further comprises an electricity generation arrangement for generating electricity from rotation of the magnetic gear member.

21. The system of claim 18, wherein the system further comprises a driving arrangement configured to drive rotation of the magnetic gear member.

22. The system of claim 21, wherein the magnetic gear arrangement is configured such that, when the magnetic gear member is not rotated by the driving arrangement, the magnetic gear arrangement has a first, inherent, gear ratio.

23. The system of claim 22, wherein the magnetic gear arrangement is configured such that, when the magnetic gear member is arranged to be rotated by the driving arrangement, the magnetic gear arrangement has a second gear ratio that is related to the first, inherent, gear ratio as defined by:
(Sₘₘ−S_{fr})/R=Sₛᵣ
where Sₘₘ is the speed of the magnetic gear member, S_{fr} is the speed of the first rotor, Sₛᵣ is the speed of the second rotor and R is the first, inherent, gear ratio.

24. The system of claim 21, wherein the driving arrangement comprises a motor having a motor shaft.

25. The system of claim 24, wherein the driving arrangement further comprises an abutment configuration attached to or forming a part of the motor shaft and which abuts against the magnetic gear member.

26. The system of claim 2, wherein the magnetic gear arrangement comprises a first rotor, a second rotor, and a magnetic gear member located, in use, in-between the first rotor and the second rotor, and wherein the magnetic gear member is moveable into and out of a position substantially in-between the first rotor and the second rotor.

27. The system of claim 26, wherein the magnetic gear member is moveable in a radial, circumferential or axial direction.

28. The system of claim 2, wherein the magnetic gear arrangement comprises a first rotor, a second rotor, and a magnetic gear member located in-between the first rotor and the second rotor, and wherein the magnetic gear member comprises a first part of the magnetic gear member and a second part of the magnetic gear member, relative movement being possible between the first part of the magnetic gear member and the second part of the magnetic gear member.

29. The system of claim 28, wherein one or both of the first part of the magnetic gear member and second part of the magnetic gear member are moveable from a first position to a second position, the first position being such that magnetic flux is prevented from passing from the first rotor to the second rotor, or from the second rotor to the first rotor, and the second position being such that magnetic flux is allowed to pass from the first rotor to the second rotor, or from the second rotor to the first rotor.

30. The system of claim 2, wherein the magnetic gear arrangement comprises a first rotor, a second rotor and a magnetic gear member located in-between the first rotor and the second rotor, and wherein the first rotor, second rotor and magnetic gear member each have a substantially cylindrical shape.

31. The system of claim 2, wherein the magnetic gear arrangement comprises a first rotor, a second rotor and a magnetic gear member located in-between the first rotor and the second rotor, and wherein the first rotor, second rotor and magnetic gear member each have a substantially disc-like shape.

32. The system of claim 30, wherein the magnetic gear member is a stator of the magnetic gear arrangement.

33. The system of claim 30, wherein the first rotor and second rotor each comprises a plurality of permanent magnets.

34. The system of claim 33, wherein the magnetic gear member comprises a plurality of pole pieces.

35. The system of claim 2, wherein the moveable part of the gas expander system is rotatable.

36. The system of claim 2, wherein the shaft of the gas expander system is rotatable.

37. The system of claim 2, wherein the gas expander is one of a group comprising: a turbine, a piston-type expander, a swash-plate type expander, or a screw-type expander.

38. The system of claim 2, wherein the moveable part of the gas expander is connected to a first rotor of the magnetic gear by a first shaft, and a second rotor of the magnetic gear is connectable to the load via a second shaft.

39. The system of claim 2, wherein the load comprises one of a group comprising: an electricity generator; a hydraulic system; a mechanical transmission; a mechanical gear; an engine crankshaft.

40. The system of claim 2, wherein the gas expander is a turbine, the moveable part of the gas expander is a turbine wheel, the gas expander forming part of a turbocharger, and wherein the system further comprises the load, the load being a compressor wheel of the turbocharger.
